(19) United States
(12) Patent Application Publication
(10) Pub. No.: US 2025/0320745 A1
(43) Pub. Date: Oct. 16, 2025

(54) POLE LOCKING DEVICE FOR A SUNSHADE BASE

(71) Applicant: Benson Tung, Kaohsiung (TW)

(72) Inventor: Benson Tung, Kaohsiung (TW)

(21) Appl. No.: 18/632,854

(22) Filed: Apr. 11, 2024

(51) Int. Cl. E04H 12/22; A45B 23/00

(52) U.S. Cl. CPC E04H 12/2238; A45B 23/00; F16B 7/1454; F16B 7/16

(57) ABSTRACT

A pole locking device for a base of a sunshade comprises a coupling seat and a braking member pivotably connected to the coupling seat. When the braking member is in a braking position, a friction face of the braking member is in an interfering condition with an outer periphery of an upper pole. The coupling seat is securely coupled with the upper pole and a lower pole. When the braking member is in the braking position and the upper pole is coupled with the coupling seat, the braking member cannot prevent upward movement of the upper pole. When the braking member is in the braking position and the upper pole moves in a direction to disengage from the coupling seat, the braking member stops displacement of the upper pole.

### BACKGROUND OF THE INVENTION

The present invention relates to a locking device for locking a pole to a base of a sunshade and, more particularly, to a locking device used on a large sunshade to lock the pole to the base of the sunshade.

A large sunshade currently available on the market is generally disposed on an outdoor ground for shielding from the sunlight. The large sunshade typically includes a heavier base disposed on the ground and an umbrella device detachably coupled with the base. The umbrella device includes a pole and a plurality of ribs on which a canopy is mounted. A runner is slidably mounted on the pole. Each rib has an end pivotably connected to the runner. The canopy is unfolded or collapsed through movement of the runner along the pole. The bottom end of the pole is detachably coupled with the base which supports the umbrella device on the ground.

Since the canopy in the unfolded state has a large area, the pole is apt to disengage from the base when the canopy is subjected to wind. Therefore, a mechanism is required to fix the base and the pole to avoid disengagement when the canopy is unfolded. However, currently available mechanisms are not convenient to operate or require more time to fix the base and the pole. Furthermore, if the user forgets to fix the pole, the umbrella device may be disengaged from the base when subjected to wind force and may injure a person nearby.

### BRIEF SUMMARY OF THE INVENTION

The present invention provides a pole locking device for a base of a sunshade, with the pole locking device comprising:
a coupling seat including a lower end, an upper end, and a lug;
a lower pole securely coupled with the coupling seat and extending out of the lower end of the coupling seat;
a braking member pivotably connected to the lug at a location above a center of gravity of the braking member, wherein the braking member includes a friction block and is movable between a release position and a braking position; and
an upper pole, wherein when the friction block is located in the braking position and when the upper pole extends from the upper end into the coupling seat, an outer periphery of the upper pole comes in contact with the friction block to pivot the braking member toward the release position without stopping the upper pole from moving from the upper end toward the lower end, wherein when the upper pole received in the coupling seat moves toward the upper end, the outer periphery of the upper pole comes in contact with the friction block to pivot the braking member to the braking position, thereby avoiding the upper pole from moving toward the upper end, and wherein when the braking member is in the release position, the friction block is disengaged from the upper pole.

With the braking member in the braking position and the coupling seat coupled with either of two upper poles of different diameters, the braking member cannot prevent movement of the coupled upper pole, such that the coupling between the coupling seat and the coupled upper pole is very convenient. Furthermore, with the braking member in the braking position and the coupling seat engaged with the upper pole, when the upper pole displaces through a small travel away from the coupling seat, the friction block will clamp the coupled upper pole more tightly and generate greater frictional force. Thus, the coupled upper pole is more difficult to disengage from the coupling seat.

In an example, the upper pole is a tube extending from an umbrella device of the sunshade. The umbrella device includes a canopy. The lower pole is a tube extending from the base. The lower pole includes an end face and a first opening. The coupling seat further includes an inner flange on the upper end. The inner flange includes an inner surface facing the lower end. The end face of the lower pole abuts the inner surface. The friction block extends through the first opening and abuts against the outer periphery of the upper pole. After the upper pole is coupled with the coupling seat, the braking member automatically locks the upper pole, such that the umbrella device is difficult to disengage from the base. Therefore, the pole locking device according to the present invention provides better safety.

In an example, the coupling seat further includes a first portion and an optional second portion. The first portion includes the upper end, the lower end, and the lug of the coupling seat. An inner flange extends radially inward from the upper end of the coupling seat. The second portion includes a receiving hole having an inner diameter smaller than an inner diameter of the inner flange. When an outer diameter of the upper pole corresponds to the inner diameter of the inner flange, the second portion is not coupled with the first portion. The inner flange of the first portion supports the upper pole after the upper pole is coupled with the coupling seat. When the outer diameter of the upper pole corresponds to the inner diameter of the receiving hole, the second portion is coupled with the inner flange of the first portion. The upper pole is securely held in the receiving hole after the upper pole is coupled with the coupling seat.

The second portion may be selectively used to couple with the first portion according to the size of the upper pole, such that the coupling seat may be coupled with either of the upper poles of two different sizes, providing wider application of the pole locking device 10 according to the present invention.

In an example, the inner flange includes an outer surface and an inner surface opposite to the outer surface and facing the lower end. The second portion includes an outer flange and a skirt extending from a lower face of the outer flange along the axial direction of the coupling seat. The receiving hole extends from an upper face of the outer flange through a distal end of the skirt along the axial direction of the coupling seat. The second portion further includes a coupling portion which is elastically deformable. The coupling portion includes an engaging block protruding from the skirt. When the second portion is coupled with the first portion, the outer surface abuts the lower face of the outer flange, and the inner surface abuts the engaging block, thereby preventing the second portion from moving relative to the first portion along the axial direction of the coupling seat. When the second portion is coupled with the first portion and the upper pole is disengaged, the coupling portion is pressable to deform, disengaging the engaging block from the inner surface of the inner flange, thereby permitting disengagement of the first portion and the second portion along the axial direction of the coupling seat.

In an example, the pole locking device further comprises a pin. The lug includes two sidewalls and an interconnecting wall connected between the two sidewalls. Each of the two sidewalls includes a slot having an inner end and an outer end spaced from the inner end in a radial direction of the coupling seat. The inner end is located between the outer end and the coupling seat in the radial direction. The lug includes two insertion grooves each extending along an axis parallel to the axial direction of the coupling seat. Each of the two insertion grooves extends into an associated one of the two sidewalls and is spaced from an associated slot. The second portion further includes two positioning rods. The pin is slidably received in the two slots. The braking member is securely coupled with the pin to pivot therewith. When the second portion is disengaged from the first portion, the pin is movable between the inner end and the outer end of each of the slots, and the pin abuts the outer ends of the slots while the braking member is in the braking position. When the second portion is coupled with the first portion, each of the two positioning rods extends into an associated one of the two insertion grooves, and the pin is restricted between the inner ends of the slots and the two positioning rods.

By the disposition of the two positioning rods and the inner ends of the two slots, after the second portion engages with the first portion, the pin will be restricted between the inner ends of the slots and the positioning rods. With the second portion engaged with the first portion and with the braking member in the braking position, when the braking member is in the natural state (not subjected to an external force), the friction face of the friction block will maintain in the interfering condition with the outer periphery of the coupled upper pole, such that the braking member can provide an automatic locking effect after the upper pole engages with the coupling seat.

In an example, the coupling seat further includes a first portion and an optional second portion. The first portion includes the upper end, the lower end, and the lug of the coupling seat. An inner flange extends radially inward from the upper end of the coupling seat. The inner flange includes an outer surface and an inner surface opposite to the outer surface and facing the lower end of the coupling seat. The second portion includes an outer flange and a skirt extending from a lower face of the outer flange along the axial direction of the coupling seat. The second portion further includes a receiving hole having an inner diameter smaller than an inner diameter of the inner flange. The receiving hole extends from an upper face of the outer flange through a distal end of the skirt along the axial direction of the coupling seat. The second portion further includes a coupling portion having an engaging block protruding from the skirt. When the second portion is coupled with the upper end of the first portion, the outer surface abuts the lower face of the outer flange, and the inner surface abuts the engaging block, thereby preventing the second portion from moving relative to the first portion along the axial direction of the coupling seat. The upper pole is coupled with the receiving hole.

In an example, the pole locking device further comprises a pin. The lug includes two sidewalls and an interconnecting wall connected between the two sidewalls. Each of the two sidewalls includes a slot having an inner end and an outer end spaced from the inner end in a radial direction of the coupling seat. The inner end is located between the outer end and the coupling seat in the radial direction. The lug includes two insertion grooves each extending along an axis parallel to the axial direction of the coupling seat. Each of the two insertion grooves extends into an associated one of the two sidewalls and is spaced from an associated slot. The second portion further includes two positioning rods coupled with the two insertion grooves. The pin is slidably received in the slots of the two sidewalls and is restricted between the inner ends of the slots and the two positioning rods.

By the disposition of the two positioning rods and the inner ends of the two slots, after the second portion engages with the first portion, the pin will be restricted between the inner ends of the slots and the positioning rods. With the second portion engaged with the first portion and with the braking member in the braking position, when the braking member is in the natural state (not subjected to an external force), the friction face of the friction block will maintain in the interfering condition with the outer periphery of the coupled upper pole, such that the braking member can provide an automatic locking effect after the upper pole engages with the coupling seat.

In an example, the coupling seat further includes a space extending from the upper end through the lower end along the axial direction of the coupling seat. The lug further includes two sidewalls delimiting a chamber which intercommunicates with the space. The coupling seat further includes an opening intercommunicates with the chamber and the space. The braking member is received in the chamber. The friction block includes a friction face extending through the opening into the space. The friction face is configured to hold the upper pole.

In an example, the pole locking device further comprises a weight. The braking member further includes an operating button having a pivotal portion and an operating portion extending from an outer periphery of the pivotal portion. The operating portion includes a mounting hole receiving the weight. The pivotal portion includes an eccentric pivotal hole. The friction block includes a pivotal hole aligned with the eccentric pivotal hole. The friction block is coupled with the pivotal portion. The pivotal hole is located above a center of gravity of the friction block. The pin is pivotably coupled with the eccentric pivotal hole and the pivotal hole. When the upper pole is disengaged from the coupling seat and the braking member is in the braking position, the braking member is subjected to a gravitational force to pivot to a position in which the friction face is an interfering condition with an outer periphery of the upper pole.

By the disposition of the weight in the operating portion of the operating button, when the braking member in the braking position is in a natural position not subjected to an external force, the friction face remains in an interfering condition with the outer periphery of the coupled upper pole, which is advantageous to selective coupling of upper poles of two sizes, and the braking member automatically locks the selected upper pole.

In an example, the braking member further includes an operating portion extending outside of the lug. The operating portion includes two resilient arms each having a protrusion. The lug further includes two inner protrusions respectively on the two sidewalls. When the braking member is in the braking position, the two protrusions are located below the two inner protrusions along the axial direction of the coupling seat. When the braking member is in the release position, the two protrusions are located above the two inner protrusions, and the friction block maintains in a position not interfering with the outer periphery of the upper pole.

In an example, the lower pole is a tube having an end face. The lower pole includes a first opening and a second opening adjacent to the end face. The coupling seat further includes an inner flange formed on the upper end and a coupling portion. The inner flange includes an inner surface facing the lower end. The end face of the lower pole abuts the inner surface. The coupling portion is configured to couple with the second opening to prevent the lower pole from moving relative to an axial direction of the coupling seat. The friction block extends through the first opening to abut against the outer periphery of the upper pole.

By the disposition of the coupling portion coupled with the second opening of the lower pole, when the coupling seat is coupled with an upper pole, the coupling seat and the coupled upper pole can be directly disengaged from the lower pole. Thus, when used on a sunshade, the umbrella device and the coupling seat can be jointly disengaged from the base, which is relatively convenient to engagement and disengagement of the umbrella device and the base.

In an example, the upper pole is a tube extending from an umbrella device of the sunshade. The umbrella device includes a canopy. The lower pole is a tube extending from the base. The coupling portion further includes a pressing end and a pressing block operatively connected to the pressing end. The coupling block and the pressing end are spaced from the outer periphery of the upper pole in a radial direction of the coupling seat. The pressing end and the coupling block are located in an extent of the second opening. When the pressing end is not pressed, the coupling block is coupled with the second opening. When the pressing end is pressed toward the upper pole, the coupling block disengages from the second opening to permit movement of the lower pole along the axial direction of the coupling seat.

The positioning groove of the lower pole engages with the positioning block, such that the lower pole will not pivot relative to the coupling seat. Furthermore, the coupling portion engages with the second opening, such that the lower pole is difficult to disengage from the coupling eat. Furthermore, when the pole locking device is used on the base of a sunshade or the like, the coupling therebetween is more stable to avoid undesired disengagement.

The present invention will become clearer in light of the following detailed description of illustrative embodiments of this invention described in connection with the drawings.

### DESCRIPTION OF THE DRAWINGS

FIG. 1 is an exploded, perspective view illustrating upper and lower poles and a pole locking device of an embodiment according to the present invention.

FIG. 2 is a perspective view illustrating the pole locking device according to the present invention coupled with an upper pole having an outer diameter of 48 mm.

FIG. 3 is a cross sectional view taken along section line A-A of FIG. 2.

FIG. 4 is a cross sectional view similar to FIG. 3 with the upper pole clamped by a braking member.

FIG. 5 is a cross sectional view taken along section line B-B of FIG. 4.

FIG. 6 is a cross sectional view similar to FIG. 4 with the braking member in a released position.

FIG. 7 is a diagrammatic perspective view illustrating use of the pole locking device according to the present invention on a sunshade.

FIG. 8 is a perspective view illustrating coupling of the pole locking device according to the present invention with an upper pole having an outer diameter of 38 mm.

FIG. 9 is a cross sectional view taken along section line C-C of FIG. 8.

FIG. 10 is a cross sectional view taken along section line D-D of FIG. 9.

FIG. 11 is a cross sectional view taken along section line E-E of FIG. 8.

All figures are drawn for ease of explanation of the basic teachings of the present invention only; the extensions of the figures with respect to number, position, relationship, and dimensions of the parts to form the embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “lower”, “upper”, “inner”, “outer”, “side”, “end”, “portion”, “axial”, “radial”, “outward”, “inward”, “clockwise”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

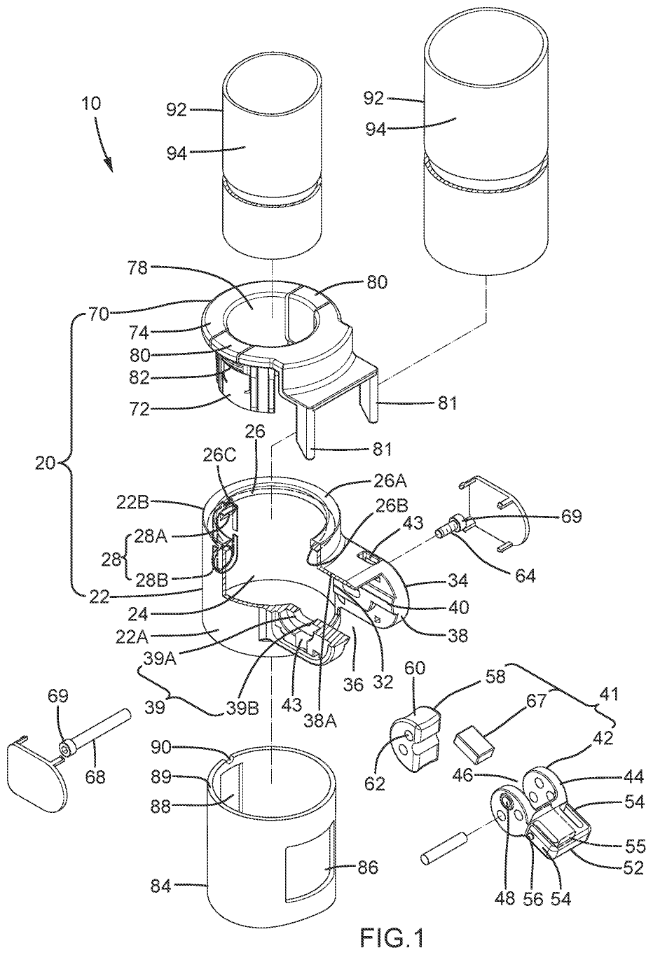

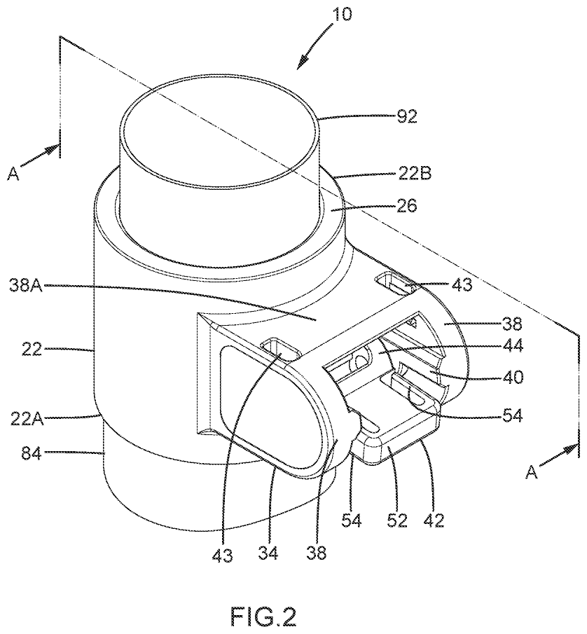

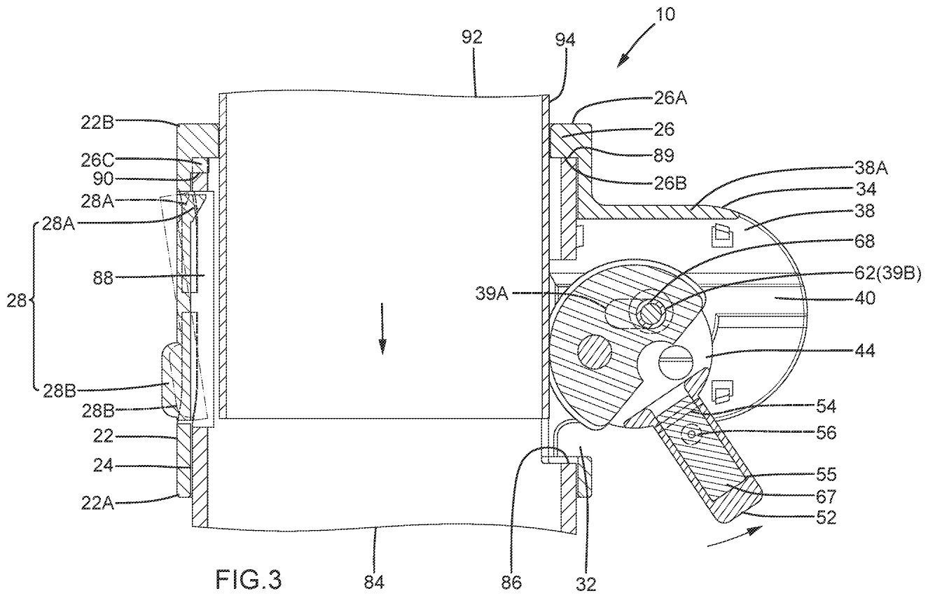

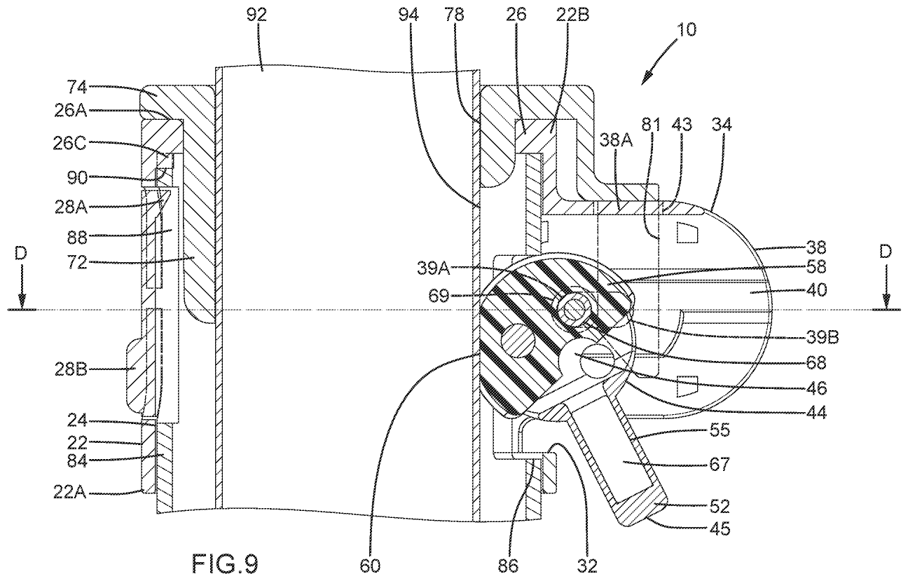

The present invention relates to a locking device for locking a pole to a base of a sunshade and, more particularly, to a locking device used on a large sunshade to lock the pole to the base of the sunshade. With reference to FIGS. 1-7, in a non-restrictive embodiment, the pole locking device 10 according to the present invention can couple with outer poles 92 of different outer diameters, and currently available outer poles 92 may have two sizes: 48 mm and 38 mm. Specifically, the pole locking device 10 according to the present invention comprises a coupling seat 20 which includes a first portion 22 for coupling with an upper pole 92 of 48 mm (the right one on FIG. 1) and a second portion 70 selectively used for coupling with an upper pole 92 of 38 mm (the left one on FIG. 1). As shown in FIGS. 3 and 9, when the upper pole 92 of 48 mm is used, the second portion 70 of the coupling seat 20 is not used. On the other hand, when the upper pole 92 of 38 mm is used, both the first portion 22 and the second portion 70 of the coupling seat 20 are assembled.

The first portion 22 includes an upper end 22B and a lower end 22A spaced from an axial direction of the coupling seat 20. The first portion 22 further includes a space 24 extends from the upper end 22B through the lower end 22A. An inner flange 26 extends radially inward from the upper end 22B and has an inner diameter smaller than an inner diameter of the lower end 22A. The inner flange 26 includes an outer surface 26A and an inner surface 26B located in the space 24 and facing the lower end 22A. The inner diameter of the inner flange 26 corresponds to the outer diameter of the upper pole 92 of 48 mm (the right one on FIG. 1). The inner flange 26 further includes a positioning block 26C extending from the inner surface 26B along the axial direction of the coupling seat 20.

The first portion 22 of the coupling seat 20 further includes a coupling portion 28. The coupling portion 28 includes a coupling block 28A extending toward the space 24 and a pressing portion 28B aligned with the coupling block 28A along an axis parallel to the axial direction of the first portion 22. Furthermore, the coupling block 28A is adjacent to the outer surface 26A and is spaced from the inner surface 26B along the axis. The coupling portion 28 may be but not limited to be formed by providing two spaced symmetric U-shaped grooves on a surface of the portion 22. Therefore, when the pressing end 28B is pressed toward the space 24, the coupling block 28A will move away from the space 24, as shown in FIG. 3.

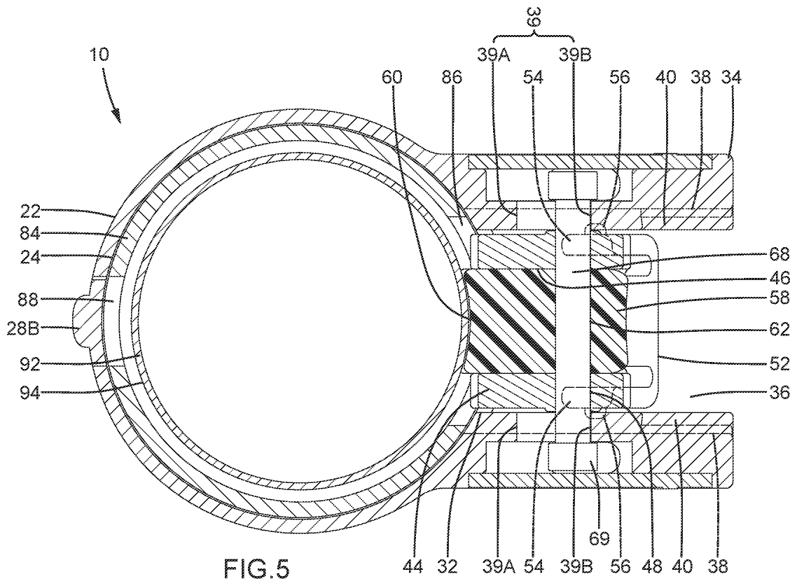

The first portion 22 further includes a lug 34 extending radially outward from the outer periphery of the first portion 22. The lug 34 includes two sidewalls 38 symmetric to each other and an interconnecting wall 38A extending between upper ends of the two sidewalls 38. The lug 34 further includes a chamber 36 between the two sidewalls 38. Each of the two sidewalls 38 includes an inner protrusion 40 on an inner face thereof and a slot 39 extending from the inner face thereof through an outer face thereof. Each slot 39 includes an inner end 39A and an outer end 39B spaced from the inner end 39A along the radial direction of the coupling seat 20 (see FIGS. 3 and 5). The inner end 39A is located between the outer end 39B and the coupling seat 20. The lug 34 includes two insertion grooves 43 each extending along an axis parallel to the axial direction of the coupling seat 20. Each of the two insertion grooves 43 extends into an associated one of the two sidewalls 38 and is spaced from an associated slot 39. The first portion 22 further includes an opening 32 extending from an inner periphery thereof through the outer periphery thereof and located between the two sidewalls 38 of the lug 34 and the upper and lower ends of the coupling seat 20. The opening 32 intercommunicates with the chamber 46 of the lug 34 and the space 24 of the coupling seat 20.

The second portion 70 includes a skirt 72 and an outer flange 74 extending radially outward from an end of the skirt 72. The skirt 72 is substantially C-shaped in cross section to match with the opening 32. The skirt 70 further includes two diametrically disposed coupling portions 80 each including an engaging block 82 protruding from the skirt 72. In a non-restrictive example, each of the two coupling portions 80 may be an elastic deformable area delimited by two symmetric cutouts extending from the skirt 72 through the outer flange 74. The second portion 70 further includes two positioning rods 81 respectively extending through the two insertion grooves 43. Each of the two positioning rods 81 is located outside of the outer flange 74. The second portion 70 further includes a receiving hole 78 extending from the outer flange 74 through a bottom end of the skirt 72 along an axial direction of the second portion 70 which is coaxial with the axial direction of the first portion 22 in this embodiment. The two coupling portions 80 are contiguous to a peripheral wall of the receiving hole 78. The receiving hole 78 has an inner diameter smaller than an inner diameter corresponding to the upper pole 92 of 38 mm (the left one on FIG. 1).

The pole locking device 10 further includes a braking member 41 pivotably connected with the lug 34. The pivotal connection between the braking member 41 and the lug 34 is located above the center of gravity of the braking member 41. The braking member 41 includes an operating button 42 and a friction block 58 coupled with the operating button 42. The operating button 42 includes a pivotal portion 44 and an operating portion 52 extending from a side of the pivotal portion 44. The pivotal portion 44 includes an eccentric pivotal hole 48. The operating portion 52 includes two symmetric resilient arms 54 spaced from each other along a pivotal axis of the braking member 41. Each of the two resilient arms 54 includes a protrusion 56. The operating button 42 further includes an engaging portion 46 and a mounting hole 55 extending from a wall of the engaging portion 46 toward an interior of the operating portion 52. A weight 67 is disposed in the mounting hole 55 and is preferably made of a metal having a larger density.

The pivotal portion 44 of the operating button 42 is received in the chamber 36 of the lug 34. The eccentric pivotal hole 48 is aligned with the slots 39. The two protrusions 56 are located between the two sidewalls 38.

The friction block 58 includes a pivotal hole 62 located above the center of gravity of the friction block 58. The friction block 58 further includes a friction face 60 an on outer side thereof. The friction block 58 may but not limited to be made an elastic material with a higher friction coefficient, such as rubber, silicone rubber, polyurethane. The friction block 58 is non-rotatably mounted in the engaging portion 46 of the operating button 42. The pivotal hole 62 is aligned with the eccentric pivotal hole 48. The friction block 58 may be but not limited to semi-circular. In a non-restrictive example, a pin extends through the friction block 58 and the pivotal portion 44, such that the friction block 58 and the pivotal portion 44 pivot jointly.

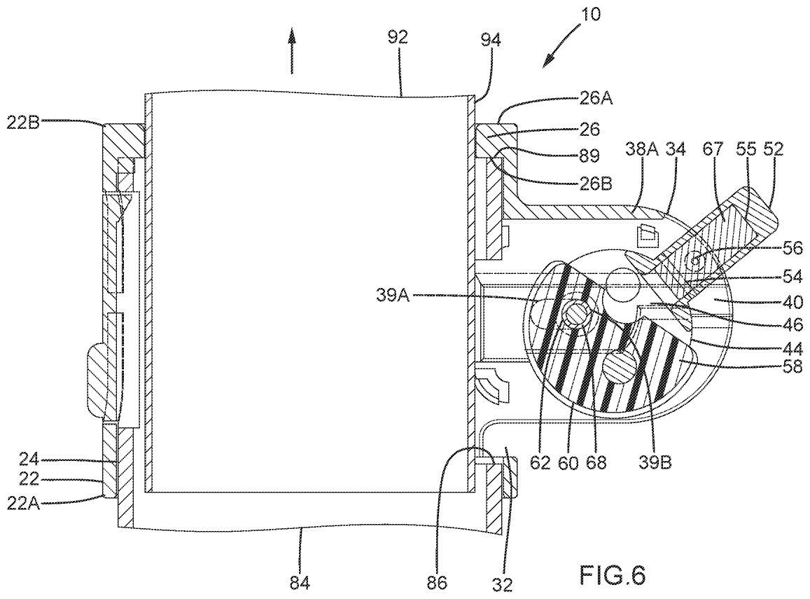

A pin device is coupled with the lug 34. In a non-restrictive example shown in FIG. 1, the pin device may include a pin 68 with an inner threading and a screw 64 with an outer threading in threading connection with the inner threading of the pin 68. Each of the pin 68 and the screw 64 has a head 69. The pin 68 is slidably received in the two slots 39. The head 69 are located outside of the slots 39. The pin 68 is pivotably connected with the braking member 41, such that the braking member 41 can pivot about the pin 68 and can pivot jointly with the pin 68 to move between the inner end 39A and the outer end 39B of each of the two slots 39. According to the form shown, the pin 68 is pivotably coupled with the eccentric pivotal hole 48 and the pivotal hole 62. With reference to FIG. 3, the operating button 42 of the braking member 41 and the friction block 58 can pivot jointly about the pin 68 between a braking position (see FIGS. 3-5) and a release position (see FIG. 6).

The pole locking device 10 is securely coupled with a lower pole 84 which may be but not limited to a tube. The lower pole 84 includes an end face 90 and a positioning groove 90 formed in the end face 89. The lower pole 84 further includes a first opening 86 and a second opening 88 diametrically opposed to the first opening 86. An upper end of the second opening 88 is adjacent to the end face 89 and the positioning groove 90. According to the form shown, the lower pole 84 may be in the form of a metal tube extending upward from a base 96 of the sunshade.

The lower pole 84 extends from the lower end 22A of the first portion 22 into the space 24. The end face 89 of the lower pole 84 abuts the inner surface 26B of the coupling seat 20, and the first opening 86 is aligned with the opening 32 of the coupling seat 20. Thus, the friction face 60 of the friction block 58 extends through the opening 32 and the first opening 86 and is located in the space 24 of the coupling seat 20. The second opening 88 of the lower pole 84 is aligned with the coupling portion 28, and the positioning block 26C engages with the positioning groove 90. Thus, the lower pole 84 cannot rotate relative to the first portion 22. The coupling block 28A is coupled with the second opening 88 and abuts an upper end face of the second opening 88. Thus, the coupling block 28A prevents movement of the lower pole 84 along the axial direction of the coupling seat 20, thereby preventing the lower pole 84 from disengaging from the first portion 22. Furthermore, an end of the lower pole 84 remote from the end face 89 extends out of the lower end 22A. Since the outer periphery of the lower pole 84 substantially abuts an inner surface of the space 24 in the coupling seat 20, the coupling mechanism between the lower pole 84 and the coupling seat 20 may not be limited to a screw extending through the first portion 22 and the lower pole 84.

The pole locking device 10 may be coupled with an upper pole 92 of 48 mm (the first portion 22 is not engaged with the second portion 70) or an upper pole 92 of 38 mm (the first portion 22 is engaged with the second portion 70). Each of the upper pole 92 of 48 mm and the upper pole 92 of 38 mm has an outer periphery 94 and may be but not limited to a metal tube. Each of the upper pole 92 of 48 mm and the upper pole 92 of 38 mm may be in the form of a metal tube extending downward from an umbrella device 98 of the sunshade.

In a case that the pole locking device 10 is coupled with the upper pole 92 of 48 mm, only the first portion 22 is used. Namely, the second portion 70 is not coupled with the first portion 22. The braking portion 41 is pivoted to the braking position. Thus, the two protrusions 56 are located below the inner protrusions 40 along the axial direction of the coupling seat 20. Under the action of the gravitational force of the weight 67 located outside of the lug 34, when the braking member 41 in the braking position is in a natural state not subjected to any external force, the friction face 60 of the friction member 58 remains in an interfering condition with the outer periphery 94 of the pole 92 of 48 mm. Furthermore, before the upper pole 92 of 48 mm is not coupled with the coupling seat 20, the pin 68 and the braking member 41 are permitted to displace between the outer end 39B and the inner end 39A of each slot 39.

With the braking member 41 in the braking position, the upper pole 92 of 48 mm extends from the upper end 22B toward the lower end 22A of the coupling seat 20 and extends into the space 24 of the coupling seat 20. The outer periphery 94 of the upper pole 92 is in contact with the friction face 60 of the friction member 58. When the upper pole 92 of 48 mm continues to move from the upper end 22B toward the lower end 22A, the braking member 41 pivots toward the release position. It is noted that movement of the upper pole 92 of 48 mm toward the lower end 22A is insufficient to pivot the braking member 41 from the braking position to the release position. Nevertheless, the braking member 41 will pivot to a position in which the frictional force between the friction face 60 and the outer periphery 94 of the upper pole 92 of 48 mm is insufficient to support the gravitational force of the weight 67. Due to the insufficient frictional force between the friction face 60 and the outer periphery 94 of the upper pole 92 of 48 mm, the braking member 41 will pivot toward the braking position under the action of the gravitational force of the weight 67, such that the frictional force between the friction face 60 and the outer periphery 94 of the upper pole 92 of 48 mm increases. This procedure repeats until the upper pole 92 of 48 mm becomes immobile. Namely, with the braking member 41 in the braking position, movement of the upper pole 92 of 48 mm from the upper end 22B toward the lower end 22A will cause repeated small angle pivotal movements of the braking member 41. The braking member 41 cannot stop the upper pole 92 of 48 mm from moving toward the lower end 22A.

It is noted that when the upper pole 92 of 48 mm is coupled with the coupling seat 20 and the braking member 41 is in the braking position, the pin 68 abuts the outer end 39B of each slot 39.

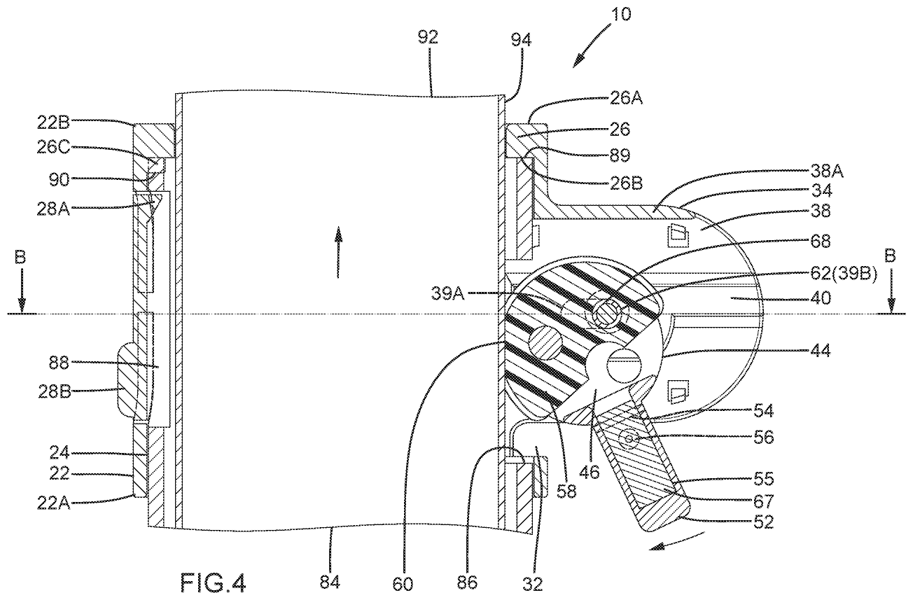

With reference to FIG. 4, given the upper pole 92 of 48 mm is coupled with the coupling seat 20 and the braking member 41 is in the braking position, when the upper pole 92 of 48 mm moves from the lower end 22A toward the upper end 22B (the upper side of FIG. 4), due to the frictional force between the friction face 60 and the outer periphery 94 of the upper pole 92 of 48 mm, the braking member 41 will pivot through a small angle (in the clockwise direction of FIG. 4) to move the friction block 58 toward the upper pole 92 of 48 mm, which increases the pressure between the friction face 60 and the outer periphery 94 of the upper pole 92 of 48 mm. Thus, the upper pole 92 of 48 mm is clamped more tightly by the braking member 41, avoiding disengagement from the coupling seat 20.

When it is desired to disengage the upper pole 92 of 48 mm of the pole locking device 10 from the coupling seat 20, the braking member 41 is pivoted from the braking position (FIG. 4) to the release position (FIG. 5). During the pivotal movement from the braking position to the release position of the braking member 41, the two protrusions 56 are squeezed by the two inner protrusions 40 to cause elastic deformation of the two resilient arms 54. Thus, the two protrusions 56 can move across the two inner protrusions 40, such that the braking member 41 can pivot smoothly to the release position in which the friction face 60 is separate from the outer periphery 94 of the upper pole 92 of 48 mm. Therefore, the upper pole 92 of 48 mm can be disengaged from the coupling seat 20. Furthermore, as shown in FIG. 6, when the braking member 41 is in the release position, the two protrusions 56 are located above the two inner protrusions 40 along the axial direction of the coupling seat 20.

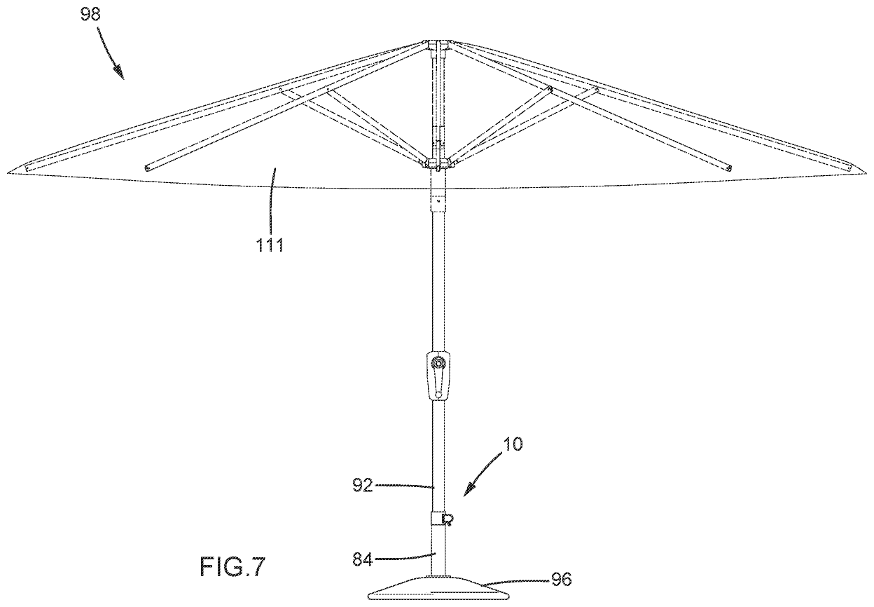

With reference to FIG. 7, with a canopy 111 of the umbrella device 98 unfolded while the braking member 41 in the braking position, when the canopy is subjected to a wind and, thus, causes slight displacement of the upper pole 92 of 48 mm away from the central axis of the base 96, the braking member 41 pivots through a small angle, such that the friction block 58 clamps the upper pole 92 of 48 mm more tightly. Thus, the umbrella device 98 is difficult to disengage from the base 96 and, thus, is unlikely to fall.

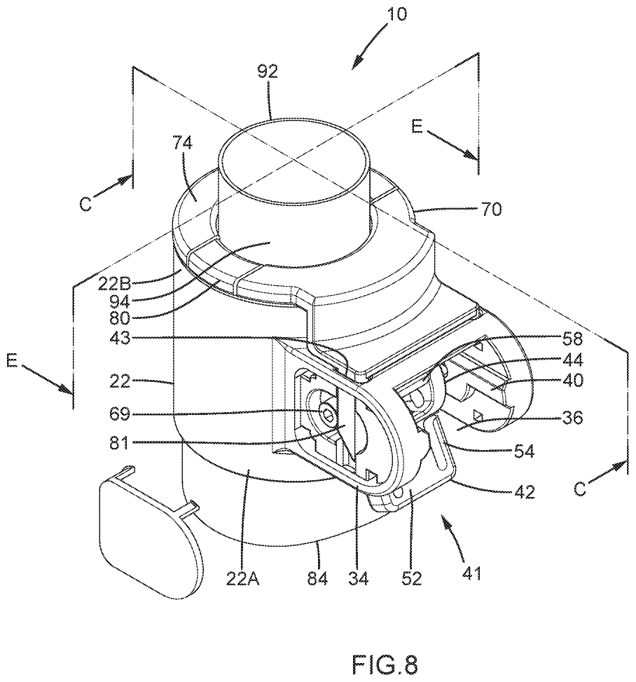

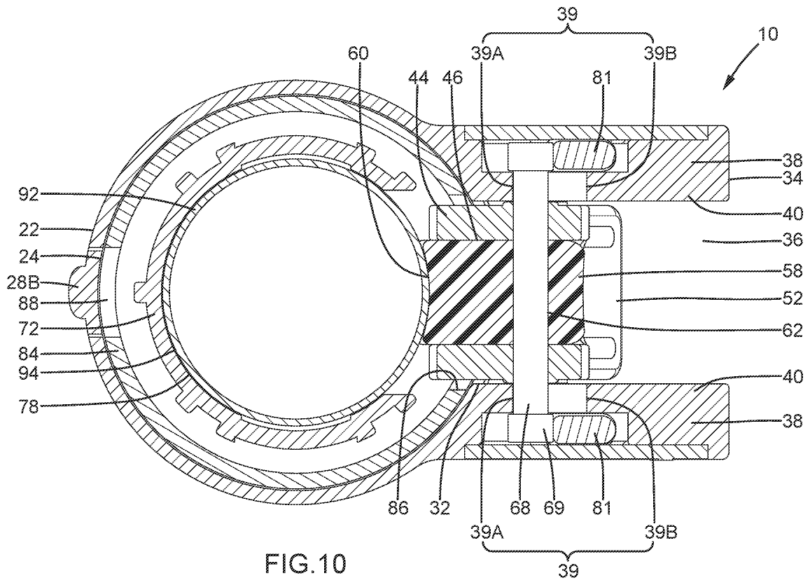

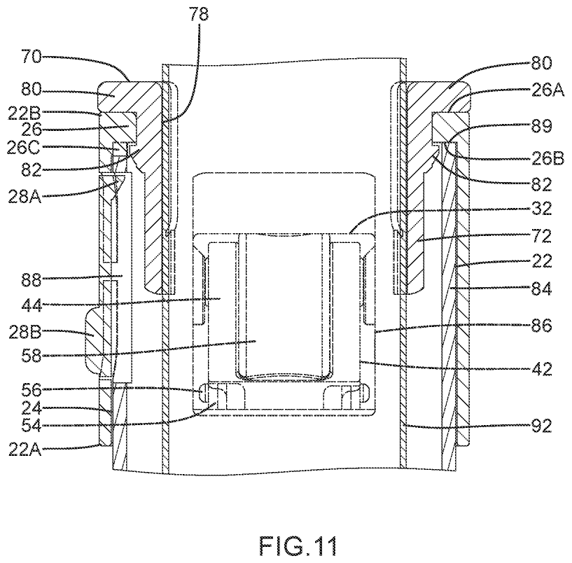

With reference to FIGS. 8-11, when it is desired to engage the pole locking device 10 with the upper pole 92 of 38 mm, the second portion 70 is engaged with the first portion 22, such that the lower surface of the outer flange 74 of the second portion 70 abuts the outer surface 26A of the inner flange 26. The skirt 72 of the second portion 70 enters the space 24 of the first portion 22 and abuts the inner flange 26. The engaging blocks 82 of the two coupling portions 80 abut the inner surface 26B of the inner flange 26. Thus, when the two engaging portions 80 are not pressed, the second portion 70 cannot move relative to the first portion 22 along the axial direction of the first portion 22.

After the second portion 70 engages with the first portion 22, the two positioning rods 81 are received in the two insertion grooves 43, and the pin 68 is restricted between the inner ends 39A of the slots 39 and the two positioning rods 81. Thus, when the braking member 41 is in the braking position, the friction face 60 of the braking member 58 is closer to the central axis of the space 24, such that when the braking member 41 in the braking position is in the natural state (not subjected to an external force), the friction face 60 remains in an interfering condition with the outer periphery 94 of the upper pole 92 of 38 mm.

After the second portion 70 engages with the first portion 22, the upper pole 92 of 38 mm can be coupled with the coupling seat 20. The receiving hole 78 of second portion 70 can support and maintain the upper pole 92 of 38 mm in a position coaxial with the lower pole 84.

With the braking member 41 in the braking position, when the upper pole 92 of 38 mm moves from the upper end 22B toward the lower end 22A, the braking member 41 will pivot toward the release position. It is noted that movement of the upper pole 92 of 38 mm toward the lower end 22A cannot pivot the braking member 41 from the braking position to the release position. Nevertheless, the braking member 41 will pivot to a position in which the frictional force between the friction face 60 and the outer periphery 94 of the upper pole 92 of 38 mm is insufficient to support the gravitational force of the weight 67. Due to the insufficient frictional force between the friction face 60 and the outer periphery 94 of the upper pole 92 of 38 mm, the braking member 41 will pivot toward the braking position under the action of the gravitational force of the weight 67, such that the frictional force between the friction face 60 and the outer periphery 94 of the upper pole 92 of 38 mm increases. This procedure repeats until the upper pole 92 of 38 mm becomes immobile. Namely, with the braking member 41 in the braking position, movement of the upper pole 92 of 38 mm from the upper end 22B toward the lower end 22A will cause repeated small angle pivotal movements of the braking member 41. The braking member 41 cannot stop the upper pole 92 of 38 mm from moving toward the lower end 22A.

With the upper pole 92 of 38 mm coupled with the coupling seat 20 and the braking member 41 in the braking position, when the upper pole 92 of 38 mm moves from the lower end 22A toward the upper end 22B (the upper side of FIG. 4), due to the frictional force between the friction face 60 and the outer periphery 94 of the upper pole 92 of 38 mm, the braking member 41 will pivot through a small angle (in the clockwise direction of FIG. 4) to move the friction block 58 toward the upper pole 92 of 38 mm, which increases the pressure between the friction face 60 and the outer periphery 94 of the upper pole 92 of 38 mm. Thus, the upper pole 92 of 38 mm is clamped more tightly by the braking member 41, avoiding disengagement from the coupling seat 20.

When it is desired to disengage the upper pole 92 of 38 mm of the pole locking device 10 from the coupling seat 20, the braking member 41 is pivoted from the braking position to the release position, such that the braking member 41 pivots to the release position in which the friction face 60 disengages from the outer periphery 94 of the upper pole 92 of 38 mm. Therefore, the upper pole 92 of 38 mm can be disengaged from the coupling seat 20. Furthermore, as shown in FIG. 6, when the braking member 41 is in the release position, the two protrusions 56 are located above the two inner protrusions 40 along the axial direction of the coupling seat 20.

After the second portion 70 is engaged with the first portion 22 and the upper pole 92 of 38 mm is disengaged, when the two coupling portions 80 are pressed along the radial direction of the coupling seat 20 and deform, the two engaging blocks 82 disengage from the inner surface 26B of the inner flange 26, such that the first portion 22 and the second portion 70 can be disengaged along the axial direction of the coupling seat 20.

While the technical features and operations of the two embodiments according to the present invention has been set forth, the advantages of the pole locking device 10 according to the present invention can be appreciated. For example, with the braking member 41 in the braking position and the coupling seat 20 coupled with either of the upper pole 92 of 48 mm and the upper pole 92 of 38 mm, the braking member 41 cannot prevent movement of the coupled upper pole 92, such that the coupling between the coupling seat 20 and the coupled upper pole 92 is very convenient. Furthermore, with the braking member 41 in the braking position and the coupling seat 20 engaged with the upper pole 92, when the upper pole 92 displaces through a small travel away from the coupling seat 20, the friction block 58 will clamp the coupled upper pole 92 more tightly and generate greater frictional force. Thus, the coupled upper pole 92 is more difficult to disengage from the coupling seat 20. Namely, after the upper pole 92 is coupled with the coupling seat 20, the braking member 41 automatically locks the upper pole 92, such that the umbrella device 98 is difficult to disengage from the base 96. Therefore, the pole locking device 10 according to the present invention provides better safety.

By the disposition of the weight 67 in the operating portion 52 of the operating button 42, when the braking member 41 in the braking position is in a natural position not subjected to an external force, the friction face 60 remains in an interfering condition with the outer periphery 94 of the coupled upper pole 92, which is advantageous to selective coupling of upper poles 92 of two sizes, and the braking member 41 automatically locks the selected upper pole 92.

The second portion 70 may be selectively used to couple with the first portion 20 according to the size of the upper pole 92, such that the coupling seat 20 may be coupled with either of the upper poles 92 of two different sizes, providing wider application of the pole locking device 10 according to the present invention.

By the disposition of the two positioning rods 81 and the inner ends 39A of the two slots 39, after the second portion 70 engages with the first portion 22, the pin 68 will be restricted between the inner ends 39A of the slots 39 and the positioning rods 81. With the second portion 70 engaged with the first portion 22 and with the braking member 41 in the braking position, when the braking member 41 is in the natural state (not subjected to an external force), the friction face 60 of the friction block 58 will maintain in the interfering condition with the outer periphery 94 of the coupled upper pole 92, such that the braking member 41 can provide an automatic locking effect after the upper pole 92 engages with the coupling seat 20.

By the disposition of the coupling portion 28 coupled with the second opening 88 of the lower pole 84, when the coupling seat 20 is coupled with an upper pole 92, the coupling seat 20 and the coupled upper pole 92 can be directly disengaged from the lower pole 84. Thus, when used on a sunshade, the umbrella device 98 and the coupling seat 20 can be jointly disengaged from the base 96, which is relatively convenient to engagement and disengagement of the umbrella device 98 and the base 96.

The positioning groove 90 of the lower pole 84 engages with the positioning block 26C, such that the lower pole 84 will not pivot relative to the coupling seat 20. Furthermore, the coupling portion 28 engages with the second opening 88, such that the lower pole 84 is difficult to disengage from the coupling eat 20. Furthermore, when the pole locking device 10 is used on the base 96 of a sunshade or the like, the coupling therebetween is more stable to avoid undesired disengagement.

Now that the basic teachings of the present invention have been explained, many extensions and variations will be obvious to one having ordinary skill in the art. For example, the braking member 41 does not have to include the weight 67. In this case, the braking member 41 can be manually pivoted to the braking position to position the upper pole 92. Alternatively, the coupling seat 20 does not have to include the two inner protrusions 40. In this case, the braking member 41 can still pivot to move the friction face 60 of the friction block 58 to press against or disengage from the outer periphery 94 of the upper pole 92.

Alternatively, the coupling seat 20 does not have to include the second portion 70. In this case, the first portion 22 of the coupling seat 20 can still couple with an upper pole 92 of a single size (such as an upper pole 92 of 48 mm).

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A pole locking device for a base of a sunshade, with the pole locking device comprising:
a coupling seat including a lower end, an upper end, and a lug;
a lower pole securely coupled with the coupling seat and extending out of the lower end of the coupling seat;
a braking member pivotably connected to the lug at a location above a center of gravity of the braking member, wherein the braking member includes a friction block and is movable between a release position and a braking position; and
an upper pole, wherein when the friction block is located in the braking position and when the upper pole extends from the upper end into the coupling seat, an outer periphery of the upper pole comes in contact with the friction block to pivot the braking member toward the release position without stopping the upper pole from moving from the upper end toward the lower end, wherein when the upper pole received in the coupling seat moves toward the upper end, the outer periphery of the upper pole comes in contact with the friction block to pivot the braking member to the braking position, thereby avoiding the upper pole from moving toward the upper end, and wherein when the braking member is in the release position, the friction block is disengaged from the upper pole.

2. The pole locking device for the base of the sunshade as claimed in claim 1, wherein the upper pole is a tube extending from an umbrella device of the sunshade, wherein the umbrella device includes a canopy, wherein the lower pole is a tube extending from the base, wherein the lower pole includes an end face and a first opening, wherein the coupling seat further includes an inner flange on the upper end, wherein the inner flange includes an inner surface facing the lower end, wherein the end face of the lower pole abuts the inner surface, and wherein the friction block extends through the first opening and abuts against the outer periphery of the upper pole.

3. The pole locking device for the base of the sunshade as claimed in claim 1, wherein the coupling seat further includes a first portion and an optional second portion, wherein the first portion includes the upper end, the lower end, and the lug of the coupling seat, wherein an inner flange extends radially inward from the upper end of the coupling seat, wherein the second portion includes a receiving hole having an inner diameter smaller than an inner diameter of the inner flange, wherein when an outer diameter of the upper pole corresponds to the inner diameter of the inner flange, the second portion is not coupled with the first portion, wherein the inner flange of the first portion supports the upper pole after the upper pole is coupled with the coupling seat, wherein when the outer diameter of the upper pole corresponds to the inner diameter of the receiving hole, the second portion is coupled with the inner flange of the first portion, and wherein the upper pole is securely held in the receiving hole after the upper pole is coupled with the coupling seat.

4. The pole locking device for the base of the sunshade as claimed in claim 3, wherein the inner flange includes an outer surface and an inner surface opposite to the outer surface and facing the lower end, wherein the second portion includes an outer flange and a skirt extending from a lower face of the outer flange along the axial direction of the coupling seat, wherein the receiving hole extends from an upper face of the outer flange through a distal end of the skirt along the axial direction of the coupling seat, wherein the second portion further includes a coupling portion which is elastically deformable, wherein the coupling portion includes an engaging block protruding from the skirt, wherein when the second portion is coupled with the first portion, the outer surface abuts the lower face of the outer flange, and the inner surface abuts the engaging block, thereby preventing the second portion from moving relative to the first portion along the axial direction of the coupling seat, wherein when the second portion is coupled with the first portion and the upper pole is disengaged, the coupling portion is pressable to deform, disengaging the engaging block from the inner surface of the inner flange, thereby permitting disengagement of the first portion and the second portion along the axial direction of the coupling seat.

5. The pole locking device for the base of the sunshade as claimed in claim 3, further comprising a pin, wherein the lug includes two sidewalls and an interconnecting wall connected between the two sidewalls, wherein each of the two sidewalls includes a slot having an inner end and an outer end spaced from the inner end in a radial direction of the coupling seat, wherein the inner end is located between the outer end and the coupling seat in the radial direction, wherein the lug includes two insertion grooves each extending along an axis parallel to the axial direction of the coupling seat, wherein each of the two insertion grooves extends into an associated one of the two sidewalls and is spaced from an associated slot, wherein the second portion further includes two positioning rods, wherein the pin is slidably received in the two slots, wherein the braking member is securely coupled with the pin to pivot therewith, wherein when the second portion is disengaged from the first portion, the pin is movable between the inner end and the outer end of each of the slots, and the pin abuts the outer ends of the slots while the braking member is in the braking position, and wherein when the second portion is coupled with the first portion, each of the two positioning rods extends into an associated one of the two insertion grooves, and the pin is restricted between the inner ends of the slots and the two positioning rods.

6. The pole locking device for the base of the sunshade as claimed in claim 1, wherein the coupling seat further includes a first portion and an optional second portion, wherein the first portion includes the upper end, the lower end, and the lug of the coupling seat, wherein an inner flange extends radially inward from the upper end of the coupling seat, wherein the inner flange includes an outer surface and an inner surface opposite to the outer surface and facing the lower end of the coupling seat, wherein the second portion includes an outer flange and a skirt extending from a lower face of the outer flange along the axial direction of the coupling seat, wherein the second portion further includes a receiving hole having an inner diameter smaller than an inner diameter of the inner flange, wherein the receiving hole extends from an upper face of the outer flange through a distal end of the skirt along the axial direction of the coupling seat, wherein the second portion further includes a coupling portion having an engaging block protruding from the skirt, wherein when the second portion is coupled with the upper end of the first portion, the outer surface abuts the lower face of the outer flange, and the inner surface abuts the engaging block, thereby preventing the second portion from moving relative to the first portion along the axial direction of the coupling seat, and wherein the upper pole is coupled with the receiving hole.

7. The pole locking device for the base of the sunshade as claimed in claim 6, further comprising a pin, wherein the lug includes two sidewalls and an interconnecting wall connected between the two sidewalls, wherein each of the two sidewalls includes a slot having an inner end and an outer end spaced from the inner end in a radial direction of the coupling seat, wherein the inner end is located between the outer end and the coupling seat in the radial direction, wherein the lug includes two insertion grooves each extending along an axis parallel to the axial direction of the coupling seat, wherein each of the two insertion grooves extends into an associated one of the two sidewalls and is spaced from an associated slot, wherein the second portion further includes two positioning rods coupled with the two insertion grooves, and wherein the pin is slidably received in the slots of the two sidewalls and is restricted between the inner ends of the slots and the two positioning rods.

8. The pole locking device for the base of the sunshade as claimed in claim 1, wherein the coupling seat further includes a space extending from the upper end through the lower end along the axial direction of the coupling seat, wherein the lug further includes two sidewalls delimiting a chamber which intercommunicates with the space, wherein the coupling seat further includes an opening intercommunicates with the chamber and the space, wherein the braking member is received in the chamber, wherein the friction block includes a friction face extending through the opening into the space, and wherein the friction face is configured to hold the upper pole.

9. The pole locking device for the base of the sunshade as claimed in claim 5, further comprising a weight, wherein the braking member further includes an operating button having a pivotal portion and an operating portion extending from an outer periphery of the pivotal portion, wherein the operating portion includes a mounting hole receiving the weight, wherein the pivotal portion includes an eccentric pivotal hole, wherein the friction block includes a pivotal hole aligned with the eccentric pivotal hole, wherein the friction block is coupled with the pivotal portion, wherein the pivotal hole is located above a center of gravity of the friction block, wherein the pin is pivotably coupled with the eccentric pivotal hole and the pivotal hole, and wherein when the upper pole is disengaged from the coupling seat and the braking member is in the braking position, the braking member is subjected to a gravitational force to pivot to a position in which the friction face is an interfering condition with an outer periphery of the upper pole.

10. The pole locking device for the base of the sunshade as claimed in claim 9, wherein the braking member further includes an operating portion extending outside of the lug, wherein the operating portion includes two resilient arms each having a protrusion, wherein the lug further includes two inner protrusions respectively on the two sidewalls, wherein when the braking member is in the braking position, the two in protrusions are located below the two inner protrusions along the axial direction of the coupling seat, and wherein when the braking member is in the release position, the two protrusions are located above the two inner protrusions, and the friction block maintains in a position not interfering with the outer periphery of the upper pole.

11. The pole locking device for the base of the sunshade as claimed in claim 1, wherein the lower pole is a tube having an end face, wherein the lower pole includes a first opening and a second opening adjacent to the end face, wherein the coupling seat further includes an inner flange formed on the upper end and a coupling portion, wherein the inner flange includes an inner surface facing the lower end, wherein the end face of the lower pole abuts the inner surface, wherein the coupling portion is configured to couple with the second opening to prevent the lower pole from moving relative to an axial direction of the coupling seat, and wherein the friction block extends through the first opening to abut against the outer periphery of the upper pole.

12. The pole locking device for the base of the sunshade as claimed in claim 11, wherein the upper pole is a tube extending from an umbrella device of the sunshade, wherein the umbrella device includes a canopy, wherein the lower pole is a tube extending from the base, wherein the coupling portion further includes a pressing end and a pressing block operatively connected to the pressing end, wherein the coupling block and the pressing end are spaced from the outer periphery of the upper pole in a radial direction of the coupling seat, wherein the pressing end and the coupling block are located in an extent of the second opening, wherein when the pressing end is not pressed, the coupling block is coupled with the second opening, and wherein when the pressing end is pressed toward the upper pole, the coupling block disengages from the second opening to permit movement of the lower pole along the axial direction of the coupling seat.
